(19) United States
(12) Patent Application Publication
(10) Pub. No.: US 2010/0119660 A1
(43) Pub. Date: May 13, 2010

(54) Chocolate With Flavor Cell Received Therein And Method For Making The Same

(76) Inventor: Ming-Che Chang, Daya Shiang (TW)

Correspondence Address: Wang Law Firm, Inc., 4989 Peachtree Parkway,, Suite 200, Norcross, GA, 30092, US

(21) Appl. No.: 12/268,888

(22) Filed: Nov. 11, 2008

(51) Int. Cl. A23G 1/54

(52) U.S. Cl. 426/93; 426/306

(57) ABSTRACT

A chocolate is made by preparing a flavor cell that seals an amount of flavor substance in a shell, melting chocolate material and pouring the melted chocolate material into a mold, immersing the flavor cell into the melting chocolate material, cooling and solidifying the melted chocolate material, and removing the solidified chocolate from the concavity. The chocolate can have different shapes and the flavor substance is well sealed inside the shell.

### FIELD OF THE INVENTION

The present invention relates to a chocolate, more specifically relates to a method of making chocolate with an embedded flavor cell.

### BACKGROUND OF THE INVENTION

A conventional method for making a chocolate with wine enclosed therein is disclosed in FIG. 5 and generally includes a mold with a concavity 1 and liquid chocolate is applied on the surface of the concavity 1 so as to form a chocolate layer 2 with an open top 3 when the liquid chocolate is solidified. A pre-set amount of wine 4 is poured into the concavity 1 and another chocolate layer is used to seal the open top 3.

However, there are some shortcomings for the conventional method and which are:
1. It is difficult for the liquid chocolate to stay on the inclined surface of the concavity 1 and the liquid chocolate will flow toward the bottom of the concavity 1. Therefore, the manufacturers have to apply the liquid chocolate layer by layer gradually and this requires a lot of time.
2. The sealing of the open top 3 is crucial for the chocolate and difficult to achieve. If the sealing is incomplete, the flavor of the wine will be gone and the wine may leak out or be contaminated.
3. In order to have a perfect sealing, the choices for the shape of the chocolate is limited and cannot have sophisticated, outer appearances.

The present invention intends to provide a chocolate with a flavor cell and a method for making the same, the flavor cell is made from edible material and the flavor substance can be well sealed within the cell.

### SUMMARY OF THE INVENTION

The present invention relates to a method for making a chocolate with embedded flavor cell and the method comprises the following steps:
step 1: preparing a flavor cell: sealing an amount of flavor substance in a cell so as to form a flavor cell;
step 2: melting chocolate material: melting chocolate material and pouring the melted chocolate material into a mold;
step 3: immersing the flavor cell into the melting chocolate material, and
step 4: cooling and solidifying the melted chocolate material and removing the solidified chocolate from the concavity.

The primary object of the present invention is to provide a chocolate which includes a flavor cell in which filling material such as wine is received. The flavor cell is enclosed by chocolate and the flavor is not lost.

Another object of the present invention is to provide a method for making a chocolate with a flavor cell received therein and the method effectively improves the shortcomings of the conventional method and increases the taste of the chocolate.

Yet another object of the present invention is to provide a method for making a chocolate with a flavor cell received therein wherein the method is simple and can be made quickly. The outer appearance of the chocolate can be varied without restriction.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention for making the chocolate with a flavor cell received therein;

FIG. 2 is a cross sectional view to show the chocolate made by the method of the present invention;

FIG. 3 shows another embodiment of the flavor cell of the chocolate of the present invention;

FIG. 4 shows yet another embodiment of the flavor cell of the chocolate of the present invention;

FIG. 5 is a cross sectional view to show the first step of the conventional method for making the chocolate with wine received therein, and

FIG. 6 shows the cross sectional view of the chocolate with wine received therein made by the conventional method.

### DETAILED DESCRIPTION OF THE PREFERRED EMBODIMENT

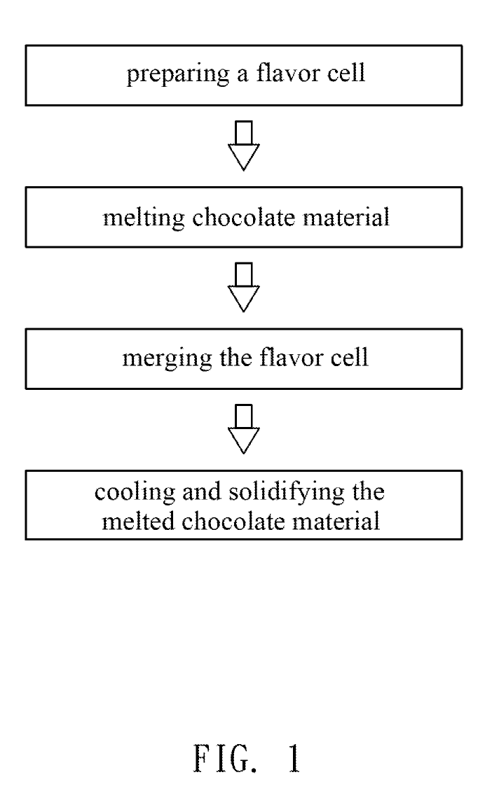

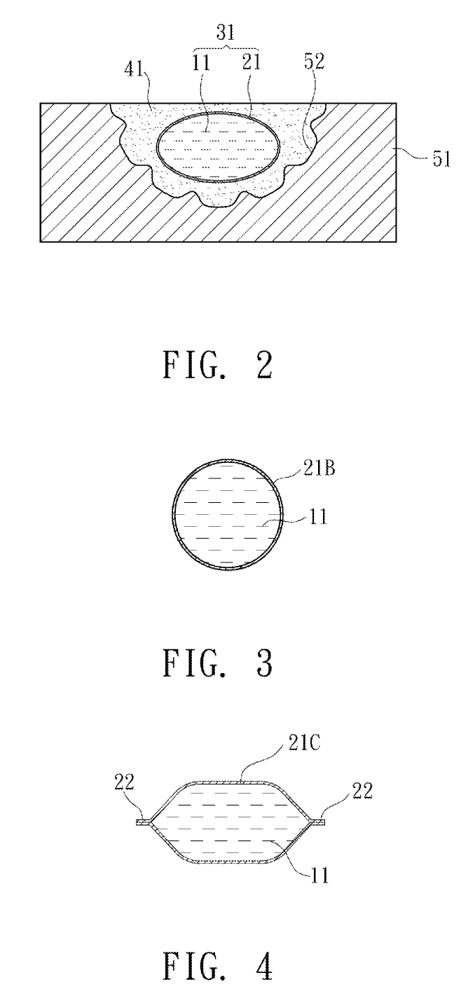

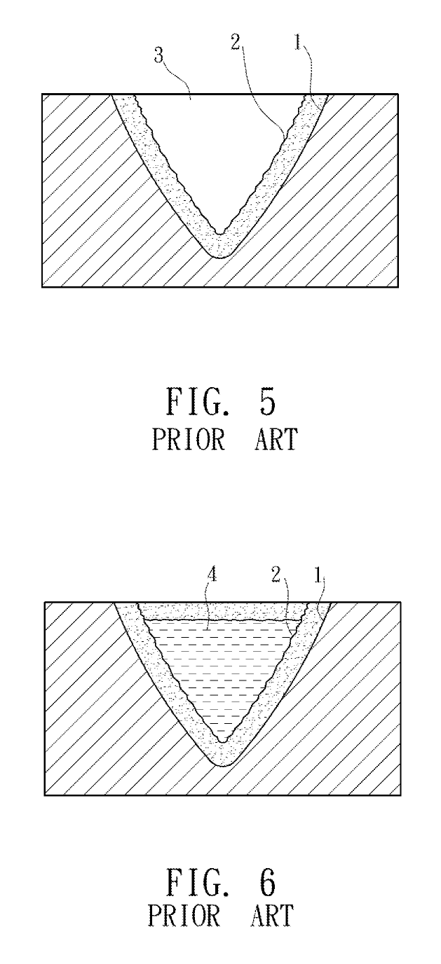

Referring to FIGS. 1 and 2, the method of the present invention for making a chocolate with an embedded flavor cell 31 comprises the following steps:
step 1: sealing an amount of flavor substance 11 in a shell 21 so as to form a flavor cell 31 (shown as “preparing a flavor cell” in FIG. 1). The shell 21 is made from any suitable edible material, including chocolate. The shell 21 encloses the flavor substance 11 perfectly and does not leak,
step 2: melting chocolate material 41 and pouring the melted chocolate material 41 into a concavity 52 in a mold 51. The chocolate material 41 is melted for a time period depending on the mount of the chocolate material 41. Large amount of chocolate may be melted for a longer time period,
step 3: the flavor cell 31 is immersed into the melted chocolate material 41 in the concavity 52 (shown as “merging the flavor cell” in FIG. 1) such that the flavor cell 31 is completely enclosed by the melted chocolate material 41.
step 4: cooling and solidifying the melted chocolate material 41 and removing the solidified chocolate from the concavity 52.

The chocolate can have different shapes of flavor cell 31 such as the shell 21 is an oval shell, the shell 21B is a circular oval shell or the shell 21C is a tubular shell and two ends 22 of the shell 21C are sealed. The flavor substance 11 can be wine, jelly, fruit vinegar, or any other desirable material.

The chocolate made by the method of the present invention includes the following features:
1. The flavor substance 11 can be completely enclosed in the shell 21 and ensured that the flavor of the flavor substance 11 does not changed or lose before or after the chocolate is done.
2. The shell 21 is perfectly sealed to avoid the flavor substance 11 from changing such that the taste of the chocolate is enhanced.
3. When the user bites the flavor cell 31, the fresh flavor substance 11 spreads in the user's mouth and the user can enjoy the best flavor of the flavor substance 11 together with the chocolate material 41.
4. Due to the perfect seal of the shell 21, the flavor substance 11 such as wine can be sealed in the shell 21 within a short time and this saves the time for making the chocolate and keeps the flavor of the wine.
5. It is easy to make the chocolate with the flavor cell 31 received therein by simply merging the flavor cell 31 into the melted chocolate material 41. The shape of the chocolate and the flavor cell 31 can be modified as needed.

While we have shown and described the embodiment in accordance with the present invention, it should be clear to those skilled in the art that further embodiments may be made without departing from the scope of the present invention.

What is claimed is:

1. A method for making a chocolate with an embedded flavor cell, comprising the steps of:
sealing an amount of flavor substance in a shell to form a flavor cell;
immersing the flavor cell into a melted chocolate material inside a mold; and
removing the chocolate material with the flavor cell from the mold.

2. The method of claim 1, further comprising the steps of:
melting the chocolate material; and
pouring the melted chocolate material into the mold.

3. The method of claim 1, further comprising the steps of:
cooling the melted chocolate material; and
solidifying the melted chocolate material.

4. The method of claim 1, wherein the chocolate material is melted for a period of time depending on the mount of the chocolate material.

5. The method as claimed in claim 1, wherein the shell is made by edible material.

6. The method as claimed in claim 1, wherein the flavor substance is wine.

7. The method as claimed in claim 1, wherein the flavor substance is jelly.

8. The method as claimed in claim 1, wherein the flavor substance is trait vinegar.

9. A chocolate comprising:
a flavor cell formed by a shell with a flavor substance, and
a layer of chocolate material enclosing the flavor cell.

10. The chocolate as claimed in claim 9, wherein the shell is an oval shell.

11. The chocolate as claimed in claim 9, wherein the shell is a circular oval shell.

12. The chocolate as claimed in claim 9, wherein die shell is a tubular shell and two ends of the shell are sealed.
